(19) United States
(12) Patent Application Publication
(10) Pub. No.: US 2014/0300740 A1
(43) Pub. Date: Oct. 9, 2014

(54) VEHICLE-MOUNTED CAMERA ADAPTER IN VEHICLE-MOUNTED MONITORING SYSTEM

(71) Applicant: Beat-Sonic Co., Ltd., Nisshin-shi (JP)

(72) Inventor: Junji FUJIOKA, Nisshin-shi (JP)

(73) Assignee: Beat-Sonic Co., Ltd., Nisshin-shi (JP)

(21) Appl. No.: 14/242,083

(22) Filed: Apr. 1, 2014

(30) Foreign Application Priority Data
Apr. 8, 2013 (JP) 2013-080423

(51) Int. Cl. B60R 1/00; H04N 7/18

(52) U.S. Cl. CPC B60R 1/002; H04N 7/183
USPC 348/148

(57) ABSTRACT

A vehicle-mounted camera adapter in a vehicle-mounted monitoring system includes a vehicle-mounted camera including a top-down view forming unit configured to form a top-down image obtained by looking down from above. The adapter includes a detection unit configured to detect a predetermined event indicative of a behavior of a vehicle body to determine whether or not a sequence of backing has proceeded to a final stage. When receiving a trigger signal, a switching control unit is configured to supply to an image switching unit a specific switching control signal to switch a converted image displayed on a monitor device to a top-down image. When the event continues for the predetermined time or more during backing, the vehicle-mounted camera adapter is configured to control the image switching unit so that the top-down image is displayed.

### CROSS-REFERENCE TO RELATED APPLICATIONS

This application is based upon and claims the benefit of priority from the prior Japanese Patent Application No. 2013-080423 filed on Apr. 8, 2013, the entire contents of which are incorporated herein by reference.

### BACKGROUND

1. Technical Field

The present disclosure relates to a vehicle-mounted monitoring system including a monitor device displaying a live image imaged by a vehicle-mounted camera, and more particularly to a camera adapter relaying the image from the vehicle-mounted camera to the monitor device.

2. Related Art

Recent digital cameras include a type provided with an image correction unit which corrects a taken image into an optimum image according to its use. This type of digital camera can form a plurality of images having different angles from a single original image. For example, a single wide-angle image taken by the use of a wide lens can be formed into an image with a standard field angle by trimming the circumference of the image, a partially enlarged image by clipping part of the image, eliminating distortion and enlarging the obtained image, and the like. The image formed by the image correction unit is displayed on a monitor screen by predetermined operation of the digital camera. In other words, the digital camera has a view angle switching function of capable of switching an image from one angle to another. This type of camera will be hereinafter referred to as “camera with a view angle switching function.” Japanese Patent Application Publication No. JP-2010-154572 discloses one type of camera with a view angle switching function.

The camera with a view angle switching function is incorporated, as a back camera, in an operation support system typified by a car navigation system. The back camera is mainly mounted on the rear of a vehicle to image a rear view. When the shift is changed to the reverse, an image of the rear view taken by the back camera is displayed on a monitor screen of the car navigation system instead of a navigation screen presenting a map or the like. When the camera with a view angle switching function is used as the back camera, the driver can select one of a plurality of images with different view angles in stopping or parking his/her vehicle.

FIG. 12 shows a conventional camera 1 with a view angle switching function used as a backup camera. The view angle switchable camera 1 is connected to a monitor 2 of car navigation system by a dedicated cable 4 provided with dedicated connectors 3. The cable 4 includes an image signal cable 4a and a view angle switching signal cable 4b. An image signal v generated and delivered by the camera 1 is transmitted through the image signal cable 4a to the monitor 2. The camera 1 is configured to start upon receipt of a back signal supplied when the driver shifts to reverse. As a result, the navigation screen displayed on the monitor 2 is instantaneously switched to an image of rearward view behind the vehicle, indicated by the image signal v transmitted from the camera 1 to the monitor 2.

View angle switch signals c1 and c2 are transmitted from the monitor 2 through the view angle switch signal cable 4b to the camera 1. The view angle switch signals c1 and c2 are provided for remote-control operation of the camera 1 at the monitor 2 side. As a result, for example, when operating a touch panel provided on a screen 2a of the monitor 2, the driver can remotely operate the view angle switching function of the camera 1.

The use of the dedicated monitor 2 dedicated to the above-described camera 1 is recommended. Thus, the abode-described image switching function cannot be used particularly, unless paired with the exclusive goods. Accordingly, an image signal and a view angle switch signal cannot be transmitted between the camera and the car navigation system when a view angle switchable camera is incorporated, as a back camera, in an existing car navigation system with no back camera. Consequently, the user cannot fully take advantage of the view angle switching function although the camera with this function is introduced.

Furthermore, the camera 1 with the view angle switching function is connected to the monitor 2 by the dedicated cable 4 provided with the dedicated connectors 3 in the conventional car navigation system, as described above. The vehicle needs to be stopped for safety when the driver switches the view angle. When wanting to back the vehicle into the garage, the driver looks around the vehicle for safety when starting to back the vehicle, ensures spaces on the right and left sides of the vehicle during backing and lastly checks the rear end of the vehicle and a stopping place. Thus, when the driver backs the vehicle while checking the rearward of the vehicle at different angles, the driver necessitates carrying out interrupt of view angle switching during backing. In this case, there is a possibility that the driver cannot concentrate on driving thereby to tend to neglect driving.

Furthermore, the driver sometimes necessitates backing the vehicle at low speeds with special attention to the backward of the vehicle in the case of backing, particularly, backing the vehicle into the garage and in the case where the driver gives way to an oncoming vehicle on a narrow road. In these cases, the driver cannot concentrate on driving when an image of the backward displayed on the monitor device is changed to one after another or when a necessary screen cannot be viewed at once.

### SUMMARY

Therefore, an object of the disclosure is to provide a vehicle-mounted camera adapter in a vehicle-mounted monitoring system, which can allow the driver to concentrate on driving during backing.

The disclosure provides a vehicle-mounted camera adapter in a vehicle-mounted monitoring system including a vehicle-mounted camera imaging a surrounding area of a vehicle inclusive of an area in the rear of the vehicle, a monitor device displaying an image or a still image imaged by the vehicle-mounted camera or a similar image and a vehicle-mounted camera adapter relaying the image supplied from the vehicle-mounted camera to the monitor device. The vehicle-mounted camera includes an image correction unit configured to perform correction conversion of an original image obtained by the vehicle-mounted camera thereby to form a plurality of corrected images, an image switching unit configured to automatically or manually switching the corrected images from a selected one to another, and a top-down image generation unit configured to generate a top-down image obtained by looking down from above. The vehicle-mounted camera adapter includes an image relay unit configured to relay the corrected image from the vehicle-mounted camera to the monitor device, a switching control unit configured to supply a normal switching control signal to the image switching unit thereby to control automatic or manual switching of the corrected images, the vehicle-mounted camera adapter being configured to relay the corrected images from the vehicle-mounted camera to the monitor device and to automatically or manually control switching of the corrected images transmitted from the vehicle-mounted camera when backing of the vehicle is started and the corrected image is to be displayed on the monitor device, a detection unit configured to detect a predetermined event indicative of a behavior of a vehicle body to determine whether or not a sequence of backing has proceeded to a final stage, the detection unit including a sensor configured to supply a timer start signal when having detected the event and an event timer configured to measure an execution time of the event when receiving the timer start signal, the event timer being configured to supply a trigger signal to the switching control unit when the event is executed continuously for a predetermined time or more. In the above-described configuration, when receiving the trigger signal, the switching control unit is configured to supply to the image switching unit a specific switching control signal to switch the converted image displayed on the monitor device to the top-down image. When the event continues for the predetermined time or more during backing, the vehicle-mounted camera adapter is configured to control the image switching unit so that the top-down image is displayed.

According to the above-described configuration, the adapter includes the detection unit configured to detect a predetermined event indicative of a behavior of a vehicle body to determine whether or not a sequence of backing has proceeded to a final stage. When the detection unit detects the event, the switching control unit is controlled after lapse of a predetermined time. Accordingly, when the event continues for the predetermined time or more during backing, the adapter is configured to automatically control the image switching unit so that the top-down image is displayed.

Accordingly, when the sequence of backing has proceeded to the final stage, in cooperation with the vehicle-mounted camera including the image correction unit and the image switching unit, that is, having a view angle switching function, the adapter can automatically display on the monitor the top-down image by which an area in the vicinity of the vehicle rear is easily visible. This can prevent the image from being suddenly switched during backing. Furthermore, the top-down image of the area of the vicinity of the vehicle rear is displayed and no wide-angle image in which an object to be observed tends to become vague is displayed. Consequently, the driver can concentrate on driver performance during backing.

The disclosure also provides a vehicle-mounted camera adapter in a vehicle-mounted monitoring system including a vehicle-mounted camera imaging a surrounding area of a vehicle inclusive of an area in the rear of the vehicle, a monitor device displaying an image or a still image imaged by the vehicle-mounted camera or a similar image and a vehicle-mounted camera adapter relaying the image supplied from the vehicle-mounted camera to the monitor device. The vehicle-mounted camera adapter includes an image correction unit configured to correct an original image obtained by the vehicle-mounted camera thereby to form a plurality of corrected images, an image switching unit configured to automatically or manually switching the corrected images from a selected one to another, an image relay unit configured to relay the corrected image from the vehicle-mounted camera to the monitor device, a switching control unit configured to supply a normal switching control signal to the image switching unit thereby to control automatic or manual switching of the corrected images, the image correction unit including a top-down image forming unit configured to form a top-down image obtained by looking down from above, the vehicle-mounted camera adapter being configured to relay the corrected images from the vehicle-mounted camera to the monitor device and to automatically or manually control switching of the corrected images transmitted from the vehicle-mounted camera when backing of the vehicle is started and the corrected image is to be displayed on the monitor device, and a detection unit configured to detect a predetermined event indicative of a behavior of a vehicle body to determine whether or not a sequence of backing has proceeded to a final stage, the detection unit including a sensor configured to supply a timer start signal when having detected the event and an event timer configured to measure an execution time of the event when receiving the timer start signal, the event timer being configured to supply a trigger signal to the switching control unit when the event is executed continuously for a predetermined time or more. In the above-described configuration, when receiving the trigger signal, the switching control unit is configured to supply to the image switching unit a specific switching control signal to switch the converted image displayed on the monitor device to the top-down image. When the event continues for the predetermined time or more during backing, the vehicle-mounted camera adapter is configured to control the image switching unit so that the top-down image is displayed.

According to the above-described adapter, too, the adapter can automatically display on the monitor the top-down image by which the area in the vicinity of the vehicle rear is easily visible. This can prevent the image from being suddenly switched during backing. Furthermore, the top-down image of the area in the vicinity of the vehicle rear is displayed and no wide-angle image in which an object to be observed tends to become vague is displayed. Consequently, the driver can concentrate on driver performance during backing.

The above-described latter adapter differs from the former adapter in that the image correction unit, the top-down image forming unit and the image switching unit all provided in the vehicle-mounted camera in the former adapter are provided in the latter adapter. More specifically, the view angle switching function of performing correction conversion of an original image to form a plurality of converted images with different view angles is added to the adapter side. Even when a vehicle-mounted camera does not have a view angle switching function, the adapter is provided with the view angle switching function. Accordingly, a plurality of corrected images is obtained by correction conversion of the original image supplied from the vehicle-mounted camera. The obtained converted images are switchingly displayed on the monitor device automatically or manually, and the top-down image can be automatically displayed on the monitor device when the predetermined event is detected.

In one embodiment, when a speed at which the vehicle backs is not more than a predetermined speed, the event is caused and detected by the sensor. The reason for this control manner is that when backing proceeds to a final stage, for example, fine-adjustment of parking position or avoidance of obstacle approaching the rear end of the vehicle body is carried out during very slow speed backing in many cases.

Consequently, the image displayed on the monitor device can be automatically switched to the top-down image when a speed at which the vehicle backs is not more than a predetermined speed. This can prevent the image from being suddenly switched during backing. Furthermore, the top-down image of the area in the vicinity of the vehicle rear is displayed and no wide-angle image in which an object to be observed tends to become vague is displayed. Consequently, the driver can concentrate on driver performance during backing.

In another embodiment, the sensor is comprised of a speed sensor configured to detect a vehicle speed. A speedometer of the vehicle or a speed sensor of the car navigation system can double as the speed sensor. Consequently, the image displayed on the monitor device can be automatically switched to the top-down image by a simple configuration. Furthermore, the image can be prevented from being suddenly switched during backing. Furthermore, the top-down image of the area in the vicinity of the vehicle rear is displayed and no wide-angle image in which an object to be observed tends to become vague is displayed. Consequently, the driver can concentrate on driver performance during backing.

In further another embodiment, the sensor is configured to detect a current or voltage turn-on signal which turns on a brake lamp. Current turning on the brake lamp can be taken from a circuit for turning on the brake lamp. The turn-on signal for turning on the brake lamp can be taken from a signal line supplying the turn-on signal when the brake pedal is pressed.

Even when the brake lamp is turned on immediately after stat of backing, the event is not caused unless a predetermined time elapses. Accordingly, backing is not determined to have proceeded to the final stage when the brake lamp frequently brinks on and off, namely, when the speed is mainly adjusted by an accelerator. Consequently, the image displayed on the monitor device can be automatically switched to the top-down image by a simple configuration. Furthermore, the image can be prevented from being suddenly switched during backing. Furthermore, the top-down image of the vicinity of vehicle backward is displayed and no wide-angle image in which an object to be observed tends to become vague is displayed. Consequently, the driver can concentrate on driver performance during backing.

In further another embodiment, the sensor is comprised of a pressure sensor configured to detect a tread force applied to a brake pedal. The reason for this configuration is that the brake pedal is stepped on with a predetermined pressure or above when the vehicle backing at slow speeds comes to rest. Consequently, the image displayed on the monitor device can be automatically switched to the top-down image by a simple configuration. Furthermore, the image can be prevented from being suddenly switched during backing. Furthermore, the top-down image of the area in the vicinity of the vehicle rear is displayed and no wide-angle image in which an object to be observed tends to become vague is displayed. Consequently, the driver can concentrate on driver performance during backing.

In further another embodiment, the event is caused when a steering angle of a steering wheel is not more than a predetermined angle. The reason for this control manner is that front wheels are returned to normal positions when backing proceeds to the final stage, namely, the steering wheel is returned to a normal position in many cases.

The sensor detecting the event includes a steering angle sensor. The steering angle sensor is used in an antiskid brake system, a lane keeping assist system, a retreat parking support device which displays a movement direction on a monitor screen during backing. As the result of use of the steering angle sensor, the image displayed on the monitor device can be automatically switched to the top-down image by a simple configuration. Furthermore, the image can be prevented from being suddenly switched during backing. Furthermore, the top-down image of the area in the vicinity of the vehicle rear is displayed and no wide-angle image in which an object to be observed tends to become vague is displayed. Consequently, the driver can concentrate on driver performance during backing.

In further another embodiment, the event is caused when a distance between the vehicle and a wall surface or a pole or a similar obstacle located behind a vehicle body is not more than a predetermined distance, and the event is detected by the sensor. The reason for this control manner is that when a sequence of backing has proceeded to a final stage, particularly in backing, the vehicle is caused to approach toward the wall surface of the garage or to car-stop blocks in the parking space of parking facilities, and furthermore, the vehicle is stopped short of an obstacle when the obstacle is located in the rear of the vehicle body.

Consequently, the image displayed on the monitor device can be automatically switched to the top-down image when a distance to the obstacle becomes no more than a predetermined distance. Furthermore, sudden switching of the image can be prevented during backing, and the driver can concentrate on driver performance during backing since the top-down image of the area in the vicinity of the vehicle rear is displayed and no wide-angle image in which an object to be observed tends to become vague is displayed.

In further another embodiment, the sensor includes radar configured to irradiate the wall surface or the pole or the similar obstacle with pulse waves and to measure a time between irradiation of the pulse waves and receipt of the pulse waves thereby to measure a distance to the wall surface or the pole or the similar obstacle. The radar is installed as a back sonar of the retreat parking support system in many vehicles. As the result of use of the radar, the image displayed on the monitor device can be automatically switched to the top-down image by a simple configuration. Furthermore, the image can be prevented from being suddenly switched during backing. Furthermore, the top-down image of the area in the vicinity of the vehicle rear is displayed and no wide-angle image in which an object to be observed tends to become vague is displayed. Consequently, the driver can concentrate on driver performance during backing.

In further another embodiment, the pulse wave is an electromagnetic wave belonging to a microwave band with a frequency ranging from 1 GHz to 300 GHz. Since the microwave has a short wavelength and high directionality, the radar using the microwave can accurately measure the distance from the vehicle rear end to the obstacle.

In further another embodiment, the pulse wave is a sound wave belonging to an ultrasonic range with a frequency of 20 kHz or above. Since the microwave has a short wavelength and high directionality, the radar using the ultrasonic wave can accurately measure the distance from the vehicle rear end to the obstacle.

In further another embodiment, the sensor is an autofocus sensor configured to sample at least one predetermined point inclusive of the obstacle caught in the image taken by the vehicle-mounted camera, thereby measuring a distance to the point based on a change in a contrast near the point.

As the result of use of the autofocus sensor, the image displayed on the monitor device can be automatically switched to the top-down image by a simple configuration. Furthermore, the image can be prevented from being suddenly switched during backing. Furthermore, the top-down image of the area in the vicinity of the vehicle rear is displayed and no wide-angle image in which an object to be observed tends to become vague is displayed. Consequently, the driver can concentrate on driver performance during backing.

### BRIEF DESCRIPTION OF THE DRAWINGS

In the accompanying drawings:

FIG. 1 is a schematic block diagram showing configuration of a vehicle-mounted monitoring system according to a first embodiment;

FIG. 2 is a schematic block diagram showing a vehicle-mounted camera adapter in the vehicle-mounted monitoring system;

FIG. 3 illustrates an example of original image taken by the vehicle-mounted camera;

FIG. 4 illustrates an example of standard image supplied by the vehicle-mounted camera;

FIG. 5 illustrates an example of wide-angle image supplied by the vehicle-mounted camera;

FIG. 6 illustrates an example of original image taken by the vehicle-mounted camera;

FIG. 7 is a flowchart showing a manner of remote control of the vehicle-mounted camera by the vehicle-mounted camera adapter;

FIG. 8 is a schematic block diagram showing configuration of a vehicle-mounted monitoring system according to a second embodiment;

FIG. 9 is a schematic block diagram showing a vehicle-mounted camera adapter in the vehicle-mounted monitoring system according to the second embodiment;

FIG. 10 is a schematic block diagram showing a modified configuration of the vehicle-mounted monitoring system according to the second embodiment;

FIG. 11 is a schematic block diagram showing another modified configuration of the vehicle-mounted monitoring system according to the second embodiment; and

FIG. 12 is a schematic block diagram showing a configuration of conventional vehicle-mounted monitoring system.

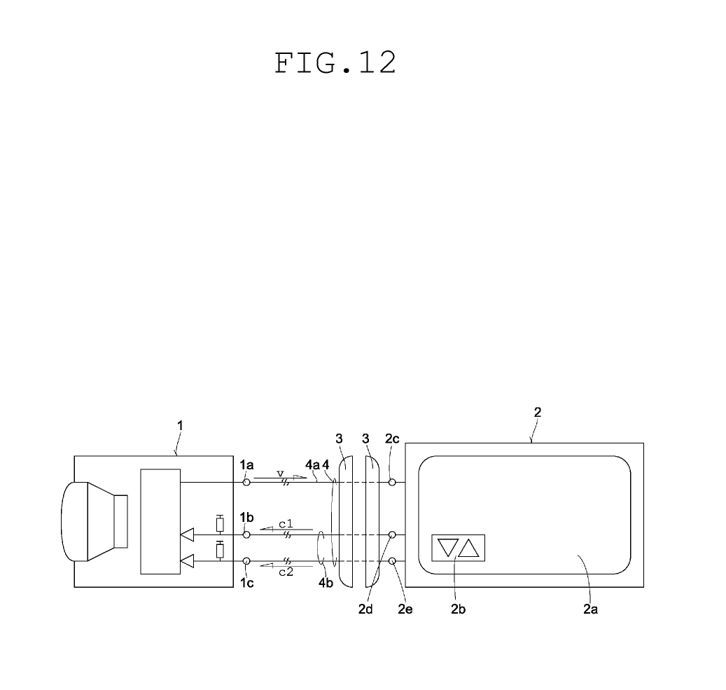

### DETAILED DESCRIPTION

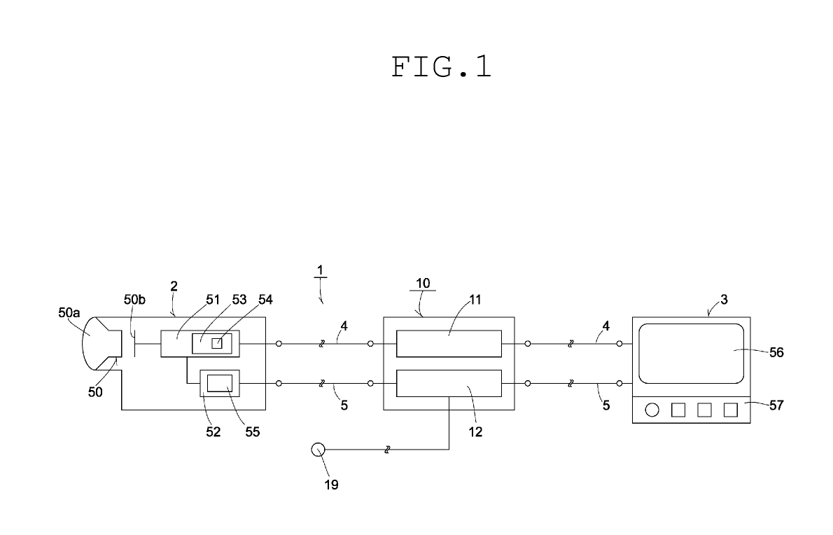

Embodiments will be described with reference to the accompanying drawings. FIG. 1 schematically shows an electrical arrangement of the vehicle-mounted monitoring system 1 according to a first embodiment. The vehicle-monitoring system 1 includes at least one vehicle-mounted camera 2 imaging an area in the vicinity of the rear of a vehicle, a monitor device 3 displaying an obtained image and a vehicle-mounted camera adapter 10 provided on a video line 4 and a communication line 5 both connecting between the vehicle-mounted camera 2 and the monitor device 3, as shown in FIG. 1.

The video line 4 and the communication line 5 are both wired. A line established as a controller area network (CAN) may be used as the communication line 5. As a result, stable video delivery and communication can be carried out since influences of disturbance such as interference are eliminated.

Furthermore, the video line 4 and the communication line 5 may be wireless. Since a wiring work can be omitted, the vehicle-mounted monitoring system 1 can be easily established without applying machining to the vehicle body. Furthermore, wireless connection may be provided between the vehicle-mounted camera 2 and the adapter 10 and wired connection may be provided between the adapter 10 and the monitor device 3. Alternatively, wired connection may be provided between the vehicle-mounted camera 2 and the adapter 10 and wireless connection may be provided between the adapter 10 and the monitor device 3. When wireless connection is provided between the adapter 10 and the monitor device 3, the monitor device 3 may be a portable type terminal device such as a smartphone, mobile phone, tablet type terminal device or notebook computer.

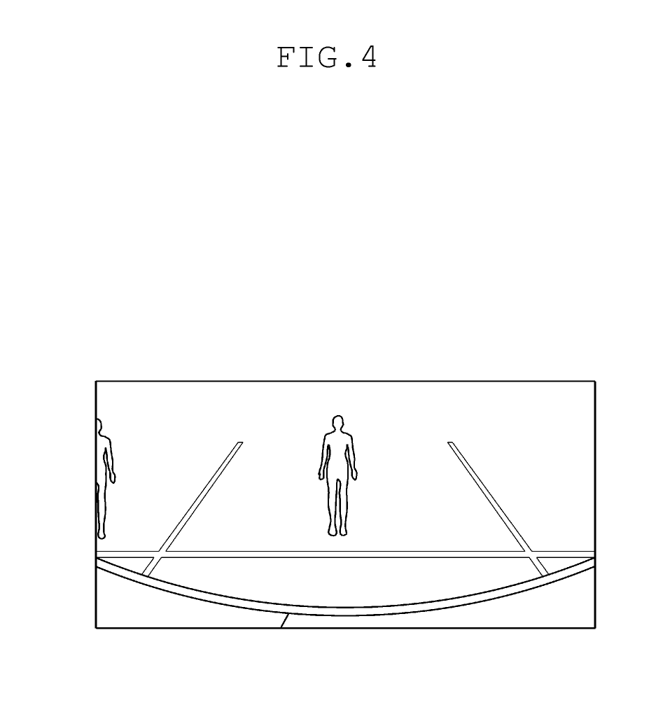

The vehicle-mounted camera 2 includes an imaging part 50, an image correction part 51 and an image control part 52. The imaging part 50 includes a lens unit 50a and an imaging device 50b. An original image taken through the lens unit 50a as shown in FIG. 4 is electrically converted to original image data by the imaging device 50b. The original image data is supplied to the image correction part 51. The image correction part 51 includes an image correction unit 53. The image correction unit 53 corrects and converts the supplied original image data into a plurality of converted image data. Converted images based on the converted image data differ from one another in a view angle as shown in FIGS. 4 to 6. The converted images will be described in detail later.

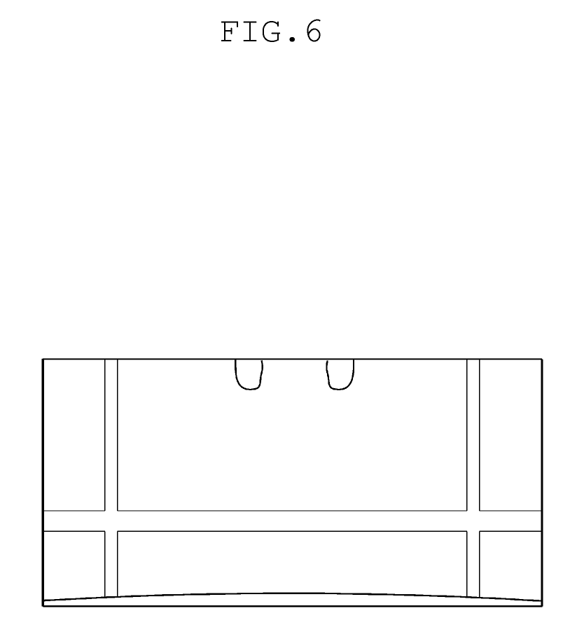

The image correction unit 53 includes a top-down image generation unit 54 as one of correction units generating the converted images. The top-down image generation unit 54 generates a top-down image which is included in the plurality of converted images generated by the image correction unit 53 and which is obtained by looking down from above, particularly as shown in FIG. 6. Converted image data of the plurality of converted images generated including the top-down image is encoded into converted image signals conforming to a predetermined communication standard thereby to be supplied from the vehicle-mounted camera 2 to the monitor device 3.

The image control section 52 includes an image switching unit 55 which is configured to supply to the monitor device 3 one of the plurality of converted images converted by the image correction part 51. The converted image to be supplied to the monitor device 3 is designated by remote operation at the monitor device 3 side. Thus, the converted image is switched and transmitted every time an image switching operation is carried out at the monitor device 3 side. Furthermore, a plurality of converted images may be repeatedly supplied in a predetermined sequence on the basis of a normal switching control signal supplied from the switching control unit 15 of the adapter 10 as will be described later. Thus, since an image displayed at the monitor device 3 side is automatically switched from one to another, the driver can concentrate on driver performance without diverting his/her attention owing to image switching.

The monitor device 3 includes a display unit 56 and a remote operation unit 57. The display unit 56 includes a monitor screen which displays the converted image. The remote operation unit 57 includes an operation switch which remote controls the image switching unit of the vehicle-mounted camera. The operation switch is comprised of a touch panel switch provided on the monitor screen or a push-button switch or a proximity switch both provided at predetermined portions of the monitor device 3.

Two image correction sections 51 may be provided in the vehicle-mounted camera 2 and the monitor device 3, and two image control sections 52 may be provided in the vehicle-mounted camera 2 and the monitor device 3. Furthermore, the image correction section 51 may be provided in one of the vehicle-mounted camera 2 and the monitor device 3, and the image control section 52 may be provided in the other. In these cases, the processing of a taken image is shared between the vehicle-mounted camera 2 side and the monitor device 3 side. Accordingly, the image processing can be sped up with the result that an image obtained by the vehicle-mounted camera 2 can be corrected at once to be displayed on the monitor device 3 easily almost without time delay.

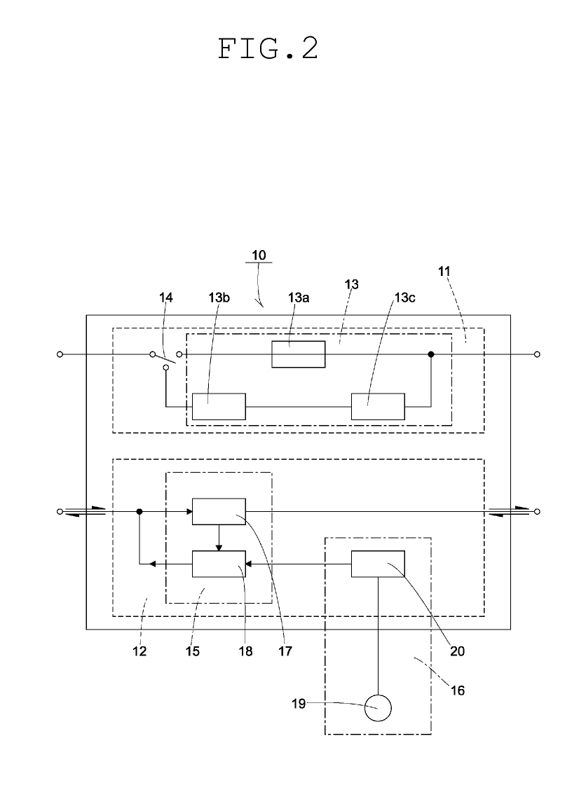

The vehicle-mounted camera 2 and the monitor device 3 both constituting the vehicle-mounted monitoring system 1 are configured as described above. The adapter 10 of the system 1 will now be described with reference to the accompanying drawings. FIG. 2 schematically shows an electrical arrangement of the adapter 10. The adapter 10 includes a relay 11 and a control 12 as shown in FIG. 2. The relay 11 includes an image relay unit 13 which relays the converted image from the vehicle-mounted camera 2 to the monitor device 3. The image relay unit 13 includes a bypass unit 13a, a decoder unit 13b and an encoder unit 13c.

The bypass unit 13a is configured to supply to the monitor device 3 a converted image signal composing the converted image data transmitted from the vehicle-mounted camera 2 without any change. As a result, when the communication standard to which the converted image signal supplied from the vehicle-mounted camera 2 conforms is acceptable at the monitor device 3 side, the image signal can be relayed without signal deterioration.

The decoder unit 13b is configured to receive the converted image signal which is coded in conformity to a predetermined communication standard and transmitted from the vehicle-mounted camera 2. The decoder unit 13b is further configured to decode the received converted image signal. The decoded converted image signal is supplied to a subsequent stage of the encoder unit 13c.

The encoder unit 13c is configured to code the converted image signal decoded by the decoder unit 13b to a signal in conformity to a predetermined communication standard. As the result of provision of the decoder unit 13b and the encoder unit 13b, the converted image signal can be relayed even when the communication standard of the converted image signal supplied from the vehicle-mounted camera 2 differs from a communication standard acceptable at the monitor device 3 side.

A switch 14 is configured to switch between the bypass unit 13a and the decoder unit 13b according to a communication standard of the supplied signal, as to which one of the bypass unit 13a and the decoder unit 13b the signal is supplied to. Although it is desirable that the switch 14 is automatically operated, the switch 14 may be manually operable. As a result, even when a manufacturer of the vehicle-mounted camera 2 differs from a manufacturer of the monitor device 3, the vehicle-mounted camera 2 and the monitor device 3 can be matched to each other. More specifically, as the result of provision of the image relay unit 13, for example, when incorporated into a genuine car navigation system, a back camera can be mounted without check as to whether or not the back camera corresponds to a genuine is acceptable to a genuine product.

The control 12 includes a switching control unit 15 which controls a type and output sequence of the converted image supplied from the vehicle-mounted camera 2 and a detection unit 16 which detects behavior of a vehicle body. The switching control unit 15 includes an identification number assignment unit 17 and a signal output unit 18. The identification number assignment unit 17 is configured to assign identification numbers to the plurality of converted images generated by the vehicle-mounted camera 2 respectively. The assignment is carried out by superposing the identification numbers on metadata embedded in the converted image data. Identification data indicative of the conversion data associated with the identification number is supplied to the signal output unit 18.

The signal output unit 18 is configured to supply a normal switching control signal to an image switching unit 55 so that the vehicle-mounted camera 2 switches the converted image periodically and sequentially to supply the converted image to the monitor device 3 according to the identification data. Furthermore, the signal output unit 18 is configured to supply a specific switching control signal so that the image is switched to a specific one of the plurality of converted images when a trigger signal is supplied from the detection unit 16 to the signal output unit 18. The image switching process to switch to the specific image will be described later. In the vehicle-mounted monitoring system 1 as shown in FIG. 1, the normal and specific switching control signals are supplied onto the communication line 5 connecting between a remote operation unit 57 of the monitor device 3 and the image switching unit 55 of the vehicle-mounted camera 2 in an interrupting manner.

The detection unit 16 is configured to detect a predetermined event which is included in behaviors of vehicle body and caused during driving. The event refers to displacement of an object to be detected, to determine whether or not the backing has proceeded to a final stage during the backing. The final stage of the backing refers to a time zone immediately before the driving vehicle is about to be stopped. The time zone differs depending upon driver's driving habit, the surroundings during the backing, a stop location of the vehicle and the like. The time zone continues about 5 seconds only as a rough indication. For example, in parking in a garage, the driver adjusts a parking position while driving the vehicle slowly to approach the vehicle rear end toward the wall surface in the rear of the vehicle or the driver squeezes within the frame line of a parking space in a parking lot. In driving, the driver backs the vehicle into a passing place to make way for an oncoming vehicle on a narrow road. These cases fall under the heading of “event.” The event will be described later.

The detection unit 16 includes a sensor 19 and an event timer 20. The sensor 19 is configured to supply a timer start signal to the event timer 20 when the event is detected. The event timer 20 is configured to start upon receipt of the timer start signal and to supply a trigger signal to a signal output unit 18 upon lapse of a predetermined time. The event timer 20 can be set to a time period between one and five seconds. As a result, the time period for which whether or not the event is continuously proceeding is determined. When a determining time is no more than one second, the vehicle proceeds to a next driving manner such as quick cut of the steering wheel in many cases but the driving speed is not reduced for fine adjustment of a parking position or the vehicle does not approach an obstacle. On the other hand, when the determining time is no less than five seconds, the driver determinately parks at the position in many cases.

The signal output unit 18 is configured to refer to identification data upon receipt of the trigger signal and to supply a switching control signal so that an image signal indicative of a specific image is supplied to the monitor device 3. In the embodiment, the specific image is desirably a top-down image obtained by looking down from above, as shown in FIG. 6.

When the event is continuously carried out for a predetermined time, it is determined that the backing has proceeded to a final stage, whereby the trigger signal is supplied. The switching control unit 15 started upon receipt of the trigger signal can control the image switching unit 55 of the vehicle-mounted camera 1 so that the converted image supplied by the vehicle-mounted camera 1 is switched to the top-down image.

Events on which the backing is determined to have proceeded to a final stage include (1) a case where the driving speed is reduced to a predetermined value or below, (2) a case where steering angles of the steering wheel and front wheels are reduced to predetermined values or below and (3) a case where a distance to the obstacle becomes no more than a predetermined distance.

These cases (1) to (3) will be described. The sensor 19 which detects the event reducing the driving speed to the predetermined value or below as in case (1) is (a) a speed sensor or (b) a sensor detecting actuation of the brake. A speed sensor provided in the vehicle can be used as the speed sensor (a). As a result, the speed sensor can be easily associated with an actual speed of the vehicle with the result that the manufacturing cost of the adapter can be suppressed. Furthermore, a speed meter using GPS of the car navigation system and a clock may be used as the speed sensor.

The speed sensor supplies a timer start signal to the event timer 20 when the vehicle speed during the backing becomes the predetermined speed or below. Upon receipt of the timer start signal, the event timer 20 measures a continuous execution time for which the vehicle speed is maintained at the predetermined speed or below. When the continuous execution time is maintained for a predetermined time or more, the detection unit 16 is configured to supply a trigger signal to the switching control unit 15. The predetermined speed or a threshold of the speed sensor is desirably a slow speed (10 km/h) or below and more desirably a very low speed substantially approximate to a stopped state, such as 5 km/h or below.

The sensor 19 sensing actuation of the brake is (a) a sensor sensitive to turn-on of the brake lamp or (b) a sensor sensitive to actuation of the brake pedal. The sensor (a) sensitive to turn-on of the brake lamp is comprised of an ammeter or a voltmeter and configured to be sensitive when an electric wire turning on the brake lamp is energized or when a turn-on signal indicative of turn-on of the brake lamp is transmitted on a signal line. A brake lamp sensor sensitive to the brake lamp supplies a timer start signal to the event timer 20 when the brake lamp is turned on. Upon receipt of the timer start signal, the event timer 20 measures a continuous execution time for which the brake lamp is turned on. The detection unit 16 is configured to supply a trigger signal to the switching control unit 15 when the continuous execution continues for a predetermined time or more.

The sensor 19 sensitive to actuation of the brake pedal is comprised of a pressure sensor. The pressure sensor is configured to detect pressure applied to the brake pedal or tread power. When the tread power applied to the brake pedal becomes a predetermined pressure, the pressure sensor supplies a timer start signal to the event timer 20. Upon receipt of the timer start signal, the event timer 20 measures a continuous execution time for which the brake pedal is pressed with a predetermined tread power or above. The detection unit 16 is configured to supply a trigger signal to the switching control unit 15 when the continuous execution is maintained for a predetermined time or more. The predetermined tread power is desirably slightly lower than the tread power which completely stops the backing vehicle or ranges from 70% to 90% of the tread power. The vehicle backs at very slow speeds when the brake is actuated with the tread power.

The sensor 19 which detects the event reducing the steering angles of the steering and the front wheels to predetermined values or below as in the above-described case (2) is a steering angle sensor. The steering angle refers to a turning angle of steering wheel or wheels. The steering angle sensor detects an absolute or relative angle of the turning angle. The steering angle sensor is used to supply steering angle information about a turning angle of steering wheel or wheels to a lane keeping assist system giving the driver a warning when the vehicle deviates from the driving lane due to drowsy driving, looking aside or the like, a retreat parking support system which presents a movement direction during backing, in cooperation with a back camera, an antiskid brake system or the like.

When parking in a garage proceeds to a final stage during backing such as parking in a garage, the steering wheel is returned to a neutral position in many cases so that the vehicle body is parked along the parking frame.

In view of above-described circumstances, in the embodiment, the steering angle sensor is configured to supply a timer start signal to the event timer 20 when the turning angle of the steering wheel or wheels is reduced to a predetermined angle or below based on the steering angle information obtained from the steering angle sensor, for example, when an absolute angle becomes 50 or below. Upon receipt of the timer start signal, the event timer 20 measures a continuous execution time for which the steering angle is maintained at a predetermined angle or below. The detection unit 16 is configured to supply a trigger signal to the switching control unit 15 when the continuous execution time continues for a predetermined time period or more.

The sensor 19 detecting the event reducing the distance to the predetermined value or below as in the above-described case (3) is (a) measuring the distance by a vehicle-mounted radar and (b) measuring the distance by an autofocus function of the vehicle-mounted camera. The vehicle-mounted radar in case (a) includes (a-1) a millimeter wave radar (a-2) an ultrasonic radar.

The vehicle-mounted radar in case (a) is a pulse radar including a detection output (not shown) which emits pulse waves to an object to be detected, a detection input (not shown) onto which the pulse waves reflected on the object fall and a timer measuring a time from emitting to incidence of the pulse waves. The time from the emitting from the detection output to the incidence onto the detection input is measured. This can measure a distance from the vehicle rear end to the wall surface located in the rear of the vehicle body or to an obstacle such as a fence, pole, corn or guard rail.

Pulse waves used in the pulse radar desirably have a high directionality in order to accurately measure the distance to the obstacle. A pulse wave having high directionality includes an electromagnetic wave with a short wavelength, in particular, electromagnetic waves belonging to a microwave range or ultrasonic waves.

The vehicle-mounted radar has been recently used in the retreat parking support system which detects an obstacle in the rear of the vehicle during the backing or cruise control which maintains a predetermined distance to a leading vehicle and drives the vehicle at a constant speed. Accordingly, data of distance to the rear obstacle is obtained from the existing vehicle-mounted radar and can be easily used. Consequently, the sensor 19 part can be eliminated from the adapter 10 with the result that costs for manufacture, mounting and introduction can be reduced.

The millimeter wave radar in case (a-1) is a pulse wave which is an electromagnetic wave belonging to a microwave band with a frequency ranging from 1 GHz to 300 GHz. The millimeter wave radar is configured to supply a timer start signal to the event timer 20 when the distance from the vehicle rear end to the obstacle located in the rear of the vehicle is the predetermined distance or below. Upon receipt of the timer start signal, the event timer 20 measures a continuous time during which the measured distance is equal to or below the predetermined distance. The detection unit 16 is configured to supply a trigger signal to the switching control unit 15 when the continuous time is maintained for a predetermined time or more.

The ultrasonic radar in case (a-2) uses as the pulse wave an ultrasonic wave belonging to an ultrasonic range with a frequency of 20 kHz or above. The ultrasonic radar is configured to supply a timer start signal to the event timer 20 when the distance from the vehicle rear end to the obstacle located in the rear of the vehicle is the predetermined distance or below. Upon receipt of the timer start signal, the event timer 20 measures a continuous time during which the measured distance is equal to or below the predetermined distance. The detection unit 16 is configured to supply a trigger signal to the switching control unit 15 when the continuous time is maintained for a predetermined time or more.

An autofocus sensor in the above-described case (b) uses the auto focus function of the vehicle-mounted camera 2. The auto focus function of a digital camera generally detects contrast of a taken image to measure a focal point distance. This contrast detection manner relies on the fact that the contrast of an image is reduced when the image is defocused and the contrast of the image becomes maximum when the image comes into focus.

The vehicle-mounted camera 2 desirably has a plurality of specific regions on an imaging device surface to detect and is desirably configured to be capable of executing multipoint distance measurement. In this case, the vehicle-mounted camera 2 automatically selects and samples one point in the specific regions, at which point the contrast is sharp. The contrast in the specific region is measured, whereby a distance to the rear can be measured. When the vehicle-mounted camera 2 is a deep focus camera, a focus is fixed. In this case, when changes in the contrast is detected in an entire screen, a distance to a part where the contrast is firstly reduced can be estimated at about 2 m although the distance depends upon a fixed focal distance and depth of field. This part is sampled and may then be combined with the above-mentioned speed sensor to measure the distance in the rear of the vehicle body.

The autofocus sensor is configured to supply a timer start signal to the event timer 20 when the distance from the obstacle in the rear of the vehicle body to the vehicle rear end becomes no more than a predetermined distance as the result of detection by the autofocus sensor. Upon receipt of the timer start signal, the event timer 20 measures a continuous time during which the distance to a measurement point is no more than a predetermined value. The detection unit 16 supplies a trigger signal to the switching control unit 15 when the continuous time is maintained for a predetermined time or more.

As described above, by detecting a predetermined even, the backing can be assumed to have proceeded to the final stage. When the detection unit 16 supplies a trigger signal to the switching control unit 15 after lapse of a predetermined time, the backing is determined to have proceeded to the final stage. As a result, after the displayed image has been switched to the top-down image by the image switching unit 55, the displayed image can be prevented from being unintentionally switched. More specifically, since the top-down image displayed on the monitor screen 56 is retained, the driver can concentrate on driver performance during backing.

The sensor 19 detecting the event may be provided on the adapter 10 independently or a plurality of sensors 19 may be combined together. The cost can be reduced when a single sensor 19 is provided. When the plurality of sensors 19 is provided, the distance to the rearward obstacle and the condition of the vehicle being driven backward can be measured.

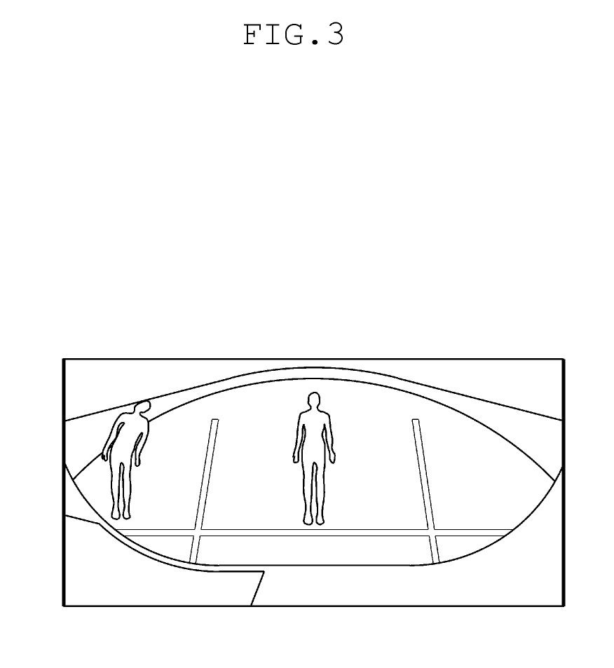

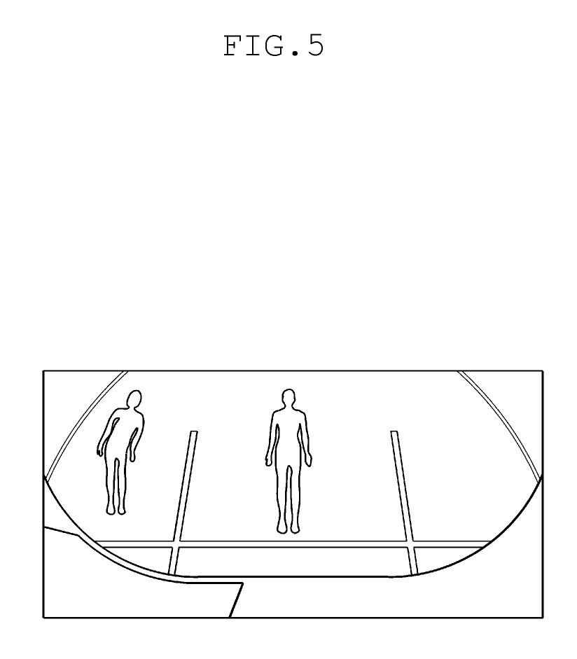

The vehicle-mounted monitoring system 1 and the adapter 10 in the system 1 are configured as described above. A control manner of switching the converted image to the top-down image by the adapter 10 will now be described. A plurality of converted images to be corrected and converted by the image correction unit 53 is formed as shown in FIGS. 3 to 6. In the embodiment, the image correction unit 53 is configured to correct and convert the original image show in FIG. 3 to converted images, that is, a standard image (see FIG. 4), a wide-angle image (see FIG. 5) and a top-down image (see FIG. 6). In particular, the image correction unit 53 includes a top-down image generation unit 54 which generates the top-down image as shown in FIG. 6.

The standard image is generated by trimming a part of the original image around a central part having less distortion so that the central part is taken out, as shown in FIG. 4. As a result, an image based on a standard view angle is generated. Since the standard image has less distortion, the driver can easily get a sense of perspective from the standard image, thereby easily confirming a space to park the vehicle, obstacles and the like.

A wide angle image is obtained by trimming an upper end of the original image so that projections of the vehicle, such as a trunk lid, on the upper end of the original image are eliminated, as shown in FIG. 5. As a result, an image with a wider view angle than the standard image is generated. Since the wide view angle image covers a range of 180-degree viewing angle, the driver can affirm presence of a person in a blind area caused by a vehicle parked at right or left side, for example.

The top-down image generated by the top-down image generation unit 54 of the image correction unit 53 is obtained by trimming the original image so that a lower half thereof is taken out and by rectifying image distortion in a peripheral part of the original image. Since the top-down image reflects a rear end part of the vehicle body through the view point as if the part is viewed from above, the driver can easily grasp a distance to the wall or an obstacle.

Thus, the vehicle-mounted camera 2 has the image correction unit 53 which generates a plurality of converted images based on the original image taken by the imaging section 50. The converted images are supplied via the adapter 10 to the monitor device 10. Furthermore, the converted images supplied to the monitor device 3 can be switched from one to another in any sequence by the image switching unit 55. Thus, the vehicle-mounted camera 2 of the embodiment is provided with a view angle switching function comprising the image correction unit 53 and the image switching unit 55.

The image switching unit 55 is remote controlled by the switching control unit 15 of the adapter 10. Consequently, the driver can manually switch the displayed image to any one of a plurality of converted images, or the converted images can be automatically switched from one to another in a circulating manner, whereby a manner of checking the rearward of the vehicle according to driving conditions.

The vehicle-mounted camera 2 in the embodiment is configured to start by a reverse signal supplied from the vehicle body side when the driver shifts to reverse. The vehicle-mounted camera 2 is also configured to start imaging substantially at the same time as the start-up to supply corrected converted images.

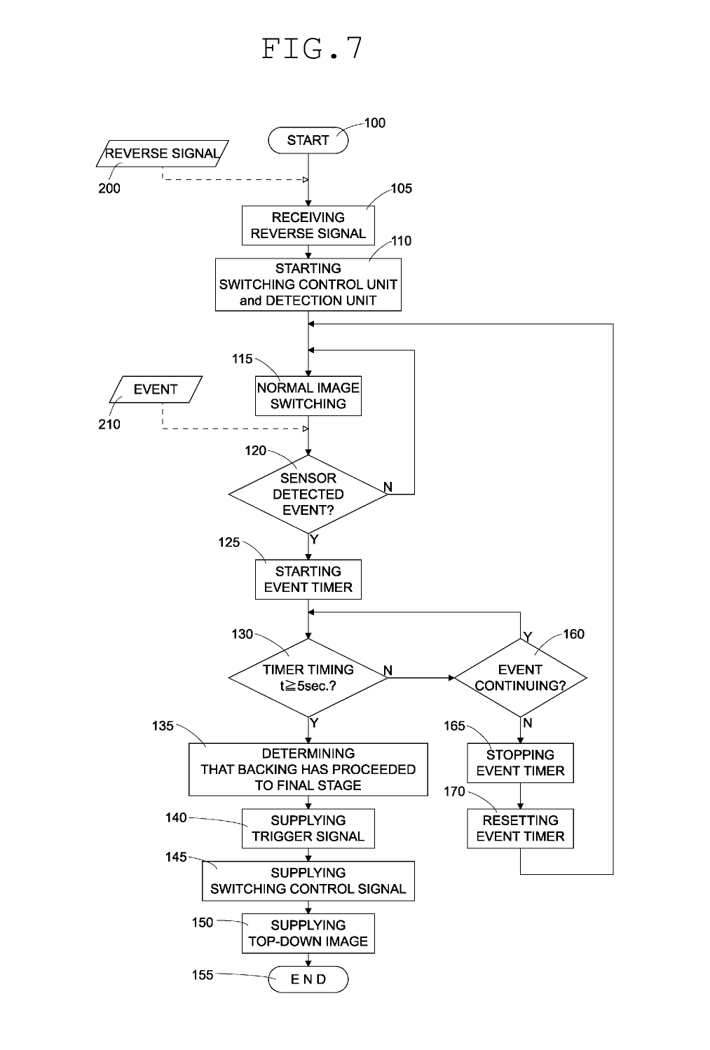

Upon receipt of the reverse signal, the adapter 10 controls the vehicle-mounted camera 2 so that a top-down image included in the converted images is supplied. This image switching process is executed in the following manner. FIG. 7 is a flowchart showing the image switching process. Processing to start a sequence of image switching process is executed at step 100. Processing to receive the reverse signal 200 is executed at step 105. The reverse signal 200 is supplied from the vehicle body side when the driver shifts to reverse. Upon receipt of the reverse signal 200, the adapter 10 executes processing to start the switching control unit 15 and the detection unit 16 at step 110.

At step 115, the adapter 10 executes processing for the switching control unit 15 to transmit a normal switching control signal to the image switching unit 55. Upon receipt of the normal switching control signal, the vehicle-mounted camera 2 supplies corrected converted images to the monitor device 3. As a result, a plurality of converted images displayed on the monitor screen 56 of the monitor device 3 is automatically switched sequentially from one to another. Accordingly, the driver can concentrate on driving performance without becoming engaged with image switching. Furthermore, upon start of the detection unit 16, the sensor 19 starts for detection of an event 210.

At step 120, the adapter 10 determines whether or not the sensor 19 has detected the event 210. When the event 210 has been detected, the adapter 10 proceeds to step 125. On the other hand, when the event 210 has not been detected, processing at step 120 is repeatedly executed. The normal image switching process at step 115 is executed until the event 210 is detected during repeated processing.

When detecting the event 210, the sensor 19 supplies a timer start signal to the event timer 20 at step 125. Upon receipt of the timer start signal, the event timer 20 is caused to start at step 125 and starts to measure a continuous execution time of the event 210.

At step 130, processing is executed to determine whether or not the continuous execution time of the event 210 has exceeded a predetermined time. A determination time during which the continuous execution time is measured is set at five seconds in the embodiment. However, the determination time should not be limited to five seconds but may be set freely. In particular, it is desirable that the determination time should be set at one to five seconds. When the determination time is shorter than one second, the event 210 would be lost after the image displayed on the monitor 3 has been changed to the specific image. In this case, there is a possibility that the specific image may be returned to the circularly displayed converted image. When the determination time is longer than five seconds, there is a possibility that the backing would end before the image displayed on the monitor device 3 is switched to the top-down image.

When the determination time exceeds five seconds, the adapter 10 proceeds to step 135. When the determination time is less than five seconds, the adapter 10 proceeds to step 160. Processing at step 160 will be described later.

At step 135, processing is executed to confirm that the backing has proceeded to a final stage. As a result, an estimated final stage of the backing is confirmed when the sensor has detected the event 210. Next, processing is executed to switch the converted image supplied by the image correction unit 53 of the vehicle-mounted camera 2 to the top-down image.

At step 140, processing is executed for the detection unit 16 to supply a trigger signal to the switching control unit 15. The trigger signal is included in switching control signals the switching control unit 15 supplies to the image switching unit 55 and requires to supply a specific switching control signal to switch to the top-down image.

At step 145, upon receipt of the trigger signal, the switching control unit 15 supplies a specific switching control signal so that the image switching unit 55 of the vehicle-mounted camera 2 supplies a top-down image to the monitor device 3. At step 150, an image signal indicative of a top-down image is transmitted from the vehicle-mounted camera 2 through the video line 4 to the monitor device 3. Upon receipt of the top-down image, the monitor device 3 switches the converted image displayed on the monitor screen 56 to the top-down image.

At step 155, processing is executed to end the image switching process. The ending process may be carried out, for example, when the engine is turned off or when the driver shifts to park. Furthermore, the image switching process to switch to the top-down image may be reset with the ending process. When the continuous execution time of the event 210 is equal to or less than five seconds at the above-described step 130, the adapter 10 proceeds to step 160 where the adapter 10 determines whether or not the event 210 continues. When the event 210 continues, the adapter 10 proceeds to step 130 to repeat determination about the continuous execution time of the event 210. When the event 210 cannot be detected and is determined to have ended, the adapter 10 proceeds to step 165 to execute a process to stop the event timer 20. The adapter 10 further proceeds to step 170 to reset the event timer 20. As a result, when the sensor 19 subsequently detects the event 210, time counting can start again. The adapter 10 then proceeds to step 115 for the normal image switching process in preparation for input of a new event 210.

According to the vehicle-mounted camera adapter 10 of the embodiment, when the vehicle-mounted camera 2 has the image correction unit 53 including the top-down image generation unit 54 which can generate the top-down image and the view angle switching function including the image switching unit 55, the top-down image can be automatically displayed on the monitor device 3. The top-down image reflects a rear end part of the vehicle body through the view point as if the part is viewed from above.

Furthermore, the original image taken by the vehicle-mounted camera 2 is corrected and converted into a plurality of converted images. Even while the converted images are being sequentially displayed on the monitor device 3 in a cyclic manner, the top-down image can be displayed in preference to the cyclic display when the backing proceeds to the final stage. Accordingly, the driver need not operate the back camera to switch the image during the backing. Furthermore, since the image is automatically switched to the top-down image, the driver can concentrate on driver performance.

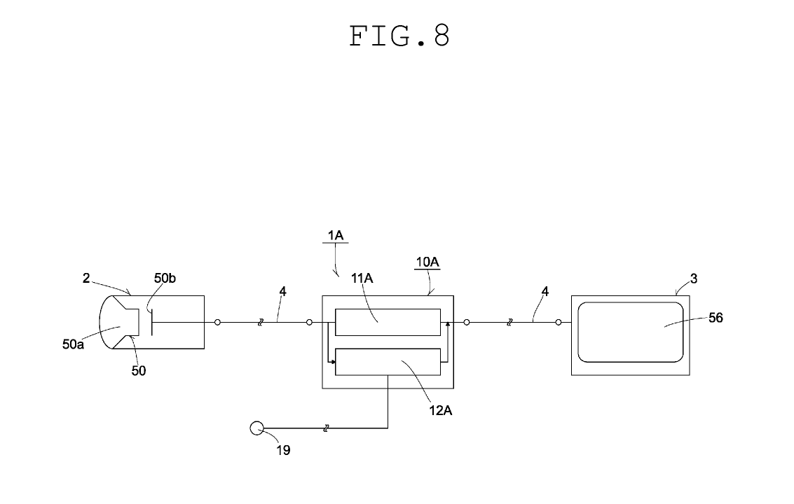

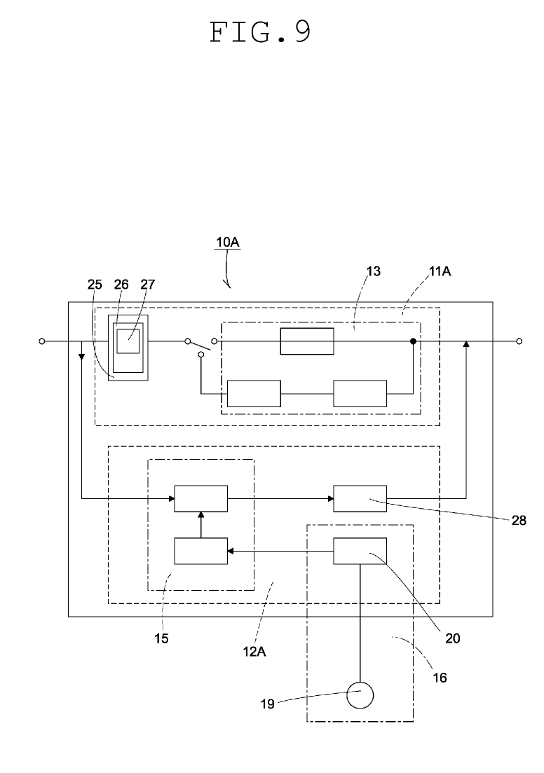

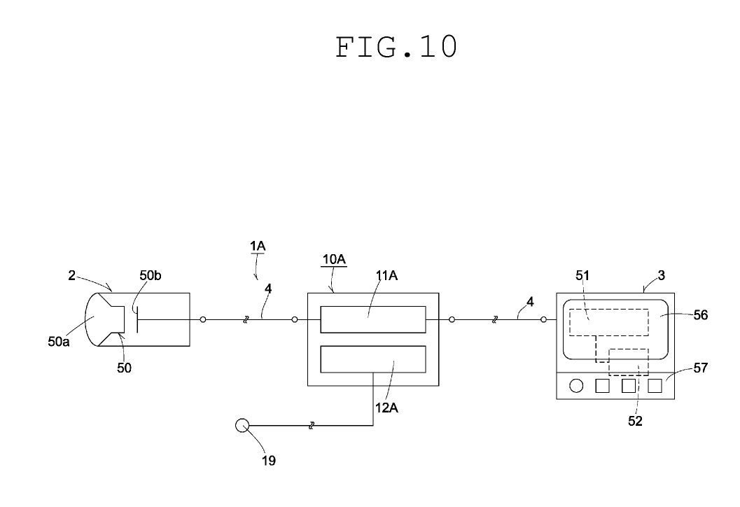

FIGS. 8 to 11 illustrate a vehicle-mounted camera adapter 10A of a second embodiment. FIG. 8 is a schematic block diagram showing an electrical arrangement of the vehicle-mounted monitoring system. FIG. 9 is a schematic block diagram showing an electrical arrangement of the vehicle-mounted camera adapter in the vehicle-mounted monitoring system.

The vehicle-mounted monitoring system 1A includes a vehicle-mounted camera 2A, the monitor device 3 and the vehicle-mounted camera adapter 10A which relays an image from the vehicle-mounted camera 2A to the monitor device 3. The vehicle-mounted monitoring system 1A has substantially the same configuration as the system described in the first embodiment. Accordingly, the description of the system will be eliminated.

The vehicle-mounted monitoring system 1A in the second embodiment differs from the system in the first embodiment in the following. The vehicle-mounted camera 2A has only the imaging section 50. Although the image correction section 51 and the image control section 52 are both provided in the vehicle-mounted camera 2 in the first embodiment, the functions of these sections 51 and 52 are provided in the vehicle-mounted camera adapter 10A in the second embodiment.

More specifically, the second embodiment differs from the first embodiment in that the image processing by the view angle switching function is carried out at the vehicle-mounted camera adapter 10A side but not at the vehicle-mounted camera 2 side. Accordingly, the view angle switching function can be added by incorporating the vehicle-mounted camera adapter 10A into the conventional vehicle-mounted monitoring system 1A having no view angle switching function.

More concrete configuration of the vehicle-mounted camera adapter 10A will now be described with reference to the drawing. The vehicle-mounted camera adapter 10A includes a relay 11A and a control 12A as shown in FIG. 9. The relay 11A has an image relay unit 13 which relays the converted images from the vehicle-mounted camera 2A to the monitor device 3. Since the image relay unit 13 has the same configuration as the relay 11 in the first embodiment, the description of the image relay unit 13 will be eliminated.

The relay 11A includes an image correction part 25 which is provided at a preceding stage of the image relay unit 13. As a result, a bypassing process or a re-encoding process to relay the converted images can be carried out after the original image taken by the vehicle-mounted camera 2 has been corrected and converted into the converted images.

The image correction part 25 has an image correction unit 26 which corrects and converts the supplied original image data thereby to generate a plurality of converted image data. Converted images based on the converted image data differ from one another in the view angle as shown in FIGS. 3 to 6. Since the details of the converted images are substantially the same as in the first embodiment, the description of the converted images will be eliminated.

The image correction unit 26 has a top-down image generation unit 27 as one of units which generate converted images. The top-down image generation unit 27 generates a top-down image reflecting an object through a view point as if the object is viewed from above. As a result, even when the vehicle-mounted camera 2A is provided with no image correction unit which corrects and converts an original image taken by the vehicle-mounted camera 2A thereby to generate converted images, the image correction unit 26 provided in the vehicle-mounted camera adapter 10A can correct and convert the original image supplied from the vehicle-mounted camera 2. Accordingly, even when the vehicle-mounted camera 2 is a somewhat old or former model, the adapter 10A can be used with the camera 2 with the result that an implementation cost can be reduced.

The control 12A includes the image switching unit 28 and the switching control unit 15 which controls the image switching unit 28 to control a type and output order of the converted images supplied from the relay part 11A. Furthermore, the control 12A has the detection unit 16 which detects behaviors of the vehicle body. The description of the switching control unit 15 and the detection unit 16 will be eliminated since these units are substantially the same as those in the first embodiment.

The image correction unit 26 corrects and converts the supplied original image data thereby to generate a plurality of converted image data as described above. The image switching unit 28 is configured to supply to the monitor device 3 one of the conversion signals, based on a normal or specific switching control signal supplied from the switching control unit 15. In particular, when supplied with the specific switching control signal, the image switching unit 28 is configured to supply the top-down image shown in FIG. 6, to the relay 11A. As a result, a plurality of converted images can be switchingly displayed automatically even when no operation part to switch a displayed image is provided at the monitor device 3 side. Consequently, the driver can concentrate on the backing without turning his/her attention to the image switching operation.

The above-described vehicle-mounted monitoring system 1A and the vehicle-mounted camera adapter 10A used with the system 1A are controlled in the same manner as in the first embodiment. Accordingly, the description of the control manners of the system 1A and the adapter 10A will be eliminated.

According to the vehicle-mounted camera adapter 10A in the vehicle-mounted monitoring system 1A, even when neither the camera 2A nor the monitor device 3 has the image correction unit 26 and the image switching unit 28, that is, even when the system has no view angle switching function, the vehicle-mounted camera adapter 2A provided between the camera 2A and the monitor device 3 corrects and converts the original image taken by the camera 2 thereby to generate a plurality of converted images. The converted images are switchingly displayed on the monitor 3, whereby circular displaying can be realized. Furthermore, the top-down image can be displayed in preference to the circular displaying when it is determined that the backing has proceeded to a final stage.

The vehicle-mounted camera 2 has the image correction part 51 and the image control 52 in the first embodiment. When the monitor device 3 has a view angle switching function including the image correction part 51 and the image control 52, the original image supplied from the camera 2 is corrected and converted in the monitor device 3 thereby to be generated into a plurality of converted images. In this case, when the vehicle-mounted camera adapter 10A is disposed on the video line 4 connecting between the camera 2 and the monitor device 3, the view angle switching function of the adapter 10A can be used instead of the view angle switching function of the monitor device 3. This can achieve a new advantageous effect that the image on the monitor 3 is automatically switched to the top-down image just before the end of backing. This new advantageous effect can never be achieved by the conventional view angle switching function of the monitor.

Furthermore, for example, assume a simple vehicle-mounted monitoring system including a simple back camera mounted on the vehicle body and a smartphone, mobile phone, tablet type terminal device or similar portable type terminal device each one of which has no image switching function. An image of an area in the rear of the vehicle body is displayed on a screen of the portable type terminal device. In this case, the back camera can be used as a back camera having a view angle switching function when used together with the vehicle-mounted camera adapter 10A of the embodiment. Component units constituting the adapter 10A of the embodiment may be mounted on a bracket for fixing the portable type terminal device to the vehicle body so that the view angle switching function is added to the bracket.

Furthermore, the aforementioned portable type terminal device has been recently provided with a position measurement unit having a global positioning system (GPS) function. A simple navigation system using this position measurement unit is sometimes carried on automotive vehicles. In this case, a program on which the component units of the adapter 10A are executed may be installed as application software 40 in the portable terminal device.

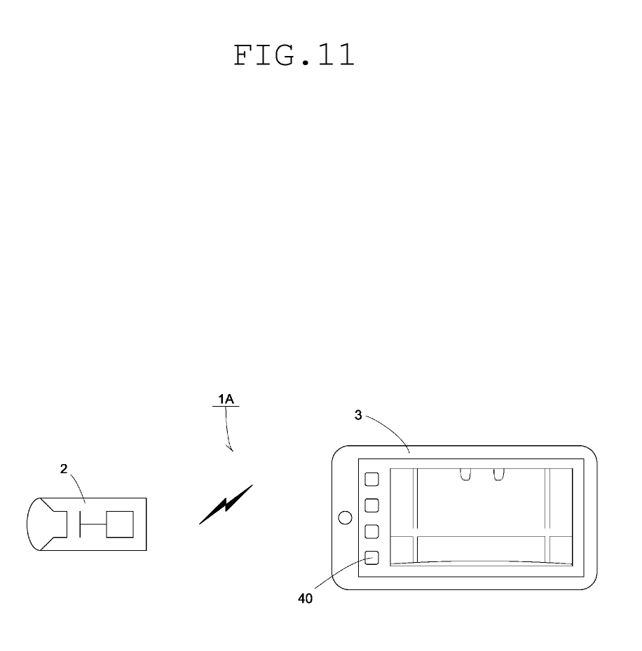

In the above-described case, for example, the installed application software 40 starts up and an image representing an area in the rear of the vehicle can be wireless transmitted from the vehicle-mounted camera to be received by the portable terminal device thereby to be displayed, as shown in FIG. 11. Furthermore, an event is provided which determines that backing has proceeded to the final stage, based on the speed detection by the GPS. The image on the monitor device 3 can be automatically switched to the top-down image when the event is detected. Thus, the vehicle-mounted monitoring system can be easily introduced by the use of the portable terminal device without complicated mounting work.

According to the above-described embodiments, when an image representing an area in the rear of the vehicle is live displayed on the monitor 3 during backing or when the back camera is actuated, the sensor 19 detects the predetermined event. After lapse of the predetermined time, when it is determined that backing has proceeded to the final stage, namely, that the vehicle being back is to stop, the image to be live displayed is automatically switched to the top-down image reflecting a rear end part of the vehicle body through the view point as if the part is viewed from above. Consequently, the driver can keep a careful watch on the top-down image representing the vicinity of the vehicle body rear end without being bothered with the image switching or frequently switched screen. Accordingly, the driver can concentrate on driver performance with the result that a collision accident on the vehicle body rear, an impact accident and the like can be prevented.

According to the above-described embodiments, the display displays the top-down image reflecting a rear end part of the vehicle body through the view point as if the part is viewed from above. Consequently, the rear end of the vehicle body can be moved into the back of the garage, and the driver can visually recognize an obstacle or a child in a dead corner in the rear of the vehicle body. This can improve the safety in the case where the driver backs the vehicle.

According to the above-described embodiments, when at least one of the vehicle-mounted camera 2 and the monitor device 3 has the view angle switching function having the image correction unit 53 and the image switching unit 55, the normal image switching process based on the normal image switching control signal can be executed, and the specific image switching process can also be executed which is based on the specific image switching control signal and switches to the top-down image.

Then, when a view angle switching function is provided at the monitor 3 side, a newly added inexpensive vehicle-mounted camera 2 having no image switching function can be selected. In this case, the view angle switching function of the monitor 3 is turned off when the vehicle-mounted camera adapter 10A of the second embodiment is connected to image input terminals at the monitor 3 side. However, the view angle switching function of the adapter 10A is used instead of the view angle switching function of the monitor 3, and by the use of the adapter 10A, the monitor 3 is provided with a new function that the monitor 3 preferentially displays the top-down image when a predetermined event occurs during backing.

On the other hand, a set of the vehicle-mounted camera 2 with the view angle switching function and the adapter 10 of the first embodiment is added, or the adapter 10A with the view angle switching function is added even in the case of an old product with no image switching function at the monitor 3 side. This can realize the view angle switching function that switches converted images to be displayed on the monitor 3. Accordingly, various forms of vehicle-mounted monitoring systems with the image switching function can be provided on driver demand, with the result that costs for introduction of the vehicle-mounted monitoring system can be reduced.

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

What is claimed is:

1. A vehicle-mounted camera adapter in a vehicle-mounted monitoring system including a vehicle-mounted camera imaging a surrounding area of a vehicle inclusive of an area in the rear of the vehicle, a monitor device displaying an image or a still image imaged by the vehicle-mounted camera or a similar image and a vehicle-mounted camera adapter relaying the image supplied from the vehicle-mounted camera to the monitor device, the vehicle-mounted camera including:
an image correction unit configured to perform correction conversion of an original image obtained by the vehicle-mounted camera thereby to form a plurality of corrected images;
an image switching unit configured to automatically or manually switching the corrected images from a selected one to another; and
a top-down image generation unit configured to generate a top-down image obtained by looking down from above, the vehicle-mounted camera adapter comprising:
an image relay unit configured to relay the corrected image from the vehicle-mounted camera to the monitor device;
a switching control unit configured to supply a normal switching control signal to the image switching unit thereby to control automatic or manual switching of the corrected images, the vehicle-mounted camera adapter being configured to relay the corrected images from the vehicle-mounted camera to the monitor device and to automatically or manually control switching of the corrected images transmitted from the vehicle-mounted camera when backing of the vehicle is started and the corrected image is to be displayed on the monitor device;
a detection unit configured to detect a predetermined event indicative of a behavior of a vehicle body to determine whether or not a sequence of backing has proceeded to a final stage, the detection unit including a sensor configured to supply a timer start signal when having detected the event and an event timer configured to measure an execution time of the event when receiving the timer start signal, the event timer being configured to supply a trigger signal to the switching control unit when the event is executed continuously for a predetermined time or more, wherein:
when receiving the trigger signal, the switching control unit is configured to supply to the image switching unit a specific switching control signal to switch the converted image displayed on the monitor device to the top-down image; and
when the event continues for the predetermined time or more during backing, the vehicle-mounted camera adapter is configured to control the image switching unit so that the top-down image is displayed.

2. A vehicle-mounted camera adapter in a vehicle-mounted monitoring system including a vehicle-mounted camera imaging a surrounding area of a vehicle inclusive of an area in the rear of the vehicle, a monitor device displaying an image or a still image imaged by the vehicle-mounted camera or a similar image and a vehicle-mounted camera adapter relaying the image supplied from the vehicle-mounted camera to the monitor device, the vehicle-mounted camera adapter comprising:
an image correction unit configured to correct an original image obtained by the vehicle-mounted camera thereby to form a plurality of corrected images;
an image switching unit configured to automatically or manually switching the corrected images from a selected one to another;
an image relay unit configured to relay the corrected image from the vehicle-mounted camera to the monitor device;
a switching control unit configured to supply a normal switching control signal to the image switching unit thereby to control automatic or manual switching of the corrected images, the image correction unit including a top-down image forming unit configured to form a top-down image obtained by looking down from above, the vehicle-mounted camera adapter being configured to relay the corrected images from the vehicle-mounted camera to the monitor device and to automatically or manually control switching of the corrected images transmitted from the vehicle-mounted camera when backing of the vehicle is started and the corrected image is to be displayed on the monitor device; and
a detection unit configured to detect a predetermined event indicative of a behavior of a vehicle body to determine whether or not a sequence of backing has proceeded to a final stage, the detection unit including a sensor configured to supply a timer start signal when having detected the event and an event timer configured to measure an execution time of the event when receiving the timer start signal, the event timer being configured to supply a trigger signal to the switching control unit when the event is executed continuously for a predetermined time or more, wherein:
when receiving the trigger signal, the switching control unit is configured to supply to the image switching unit a specific switching control signal to switch the converted image displayed on the monitor device to the top-down image; and
when the event continues for the predetermined time or more during backing, the vehicle-mounted camera adapter is configured to control the image switching unit so that the top-down image is displayed.

3. The adapter according to claim 1, wherein the event is caused and detected by the sensor when a speed at which the vehicle backs is not more than a predetermined speed.

4. The adapter according to claim 2, wherein the event is caused and detected by the sensor when a speed at which the vehicle backs is not more than a predetermined speed.

5. The adapter according to claim 3, wherein the sensor includes a speed sensor configured to detect a vehicle speed.

6. The adapter according to claim 4, wherein the sensor includes a speed sensor configured to detect a vehicle speed.

7. The adapter according to claim 3, wherein the sensor is configured to detect a current or voltage turn-on signal which turns on a brake lamp.

8. The adapter according to claim 4, wherein the sensor is configured to detect a current or voltage turn-on signal which turns on a brake lamp.

9. The adapter according to claim 3, wherein the sensor includes a pressure sensor configured to detect a tread force applied to a brake pedal.

10. The adapter according to claim 4, wherein the sensor includes a pressure sensor configured to detect a tread force applied to a brake pedal.

11. The adapter according to claim 1, wherein the event is caused when a steering angle of a steering wheel is not more than a predetermined angle, and the sensor detecting the event includes a steering angle sensor.

12. The adapter according to claim 2, wherein the event is caused when a steering angle of a steering wheel is not more than a predetermined angle, and the sensor detecting the event includes a steering angle sensor.

13. The adapter according to claim 1, wherein the event is caused when a distance between the vehicle and a wall surface or a pole or a similar obstacle located behind a vehicle body is not more than a predetermined distance, and the event is detected by the sensor.

14. The adapter according to claim 2, wherein the event is caused when a distance between the vehicle and a wall surface or a pole or a similar obstacle located behind a vehicle body is not more than a predetermined distance, and the event is detected by the sensor.

15. The adapter according to claim 13, wherein the sensor includes a radar configured to irradiate the wall surface or the pole or the similar obstacle with pulse waves and to measure a time between irradiation of the pulse waves and receipt of the pulse waves thereby to measure a distance to the wall surface or the pole or the similar obstacle.

16. The adapter according to claim 14, wherein the sensor includes a radar configured to irradiate the wall surface or the pole or the similar obstacle with a pulse wave and to measure a time between irradiation of the pulse wave and receipt of the pulse wave thereby to measure a distance to the wall surface or the pole or the similar obstacle.

17. The adapter according to claim 15, wherein the pulse wave is an electromagnetic wave belonging to a microwave band with a frequency ranging from 1 GHz to 300 GHz.

18. The adapter according to claim 16, wherein the pulse wave is an electromagnetic wave belonging to a microwave band with a frequency ranging from 1 GHz to 300 GHz.

19. The adapter according to claim 15, wherein the pulse wave is a sound wave belonging to an ultrasonic range with a frequency of 20 kHz or above.

20. The adapter according to claim 16, wherein the pulse wave is a sound wave belonging to an ultrasonic range with a frequency of 20 kHz or above.

21. The adapter according to claim 13, wherein the sensor is an autofocus sensor configured to sample at least one predetermined point inclusive of the obstacle caught in the image taken by the vehicle-mounted camera, thereby measuring a distance to the point based on a change in a contrast near the point.

22. The adapter according to claim 14, wherein the sensor is an autofocus sensor configured to sample at least one predetermined point inclusive of the obstacle caught in the image taken by the vehicle-mounted camera, thereby measuring a distance to the point based on a change in a contrast near the point.
